(19) United States
(12) Patent Application Publication
(10) Pub. No.: US 2025/0244240 A1
(43) Pub. Date: Jul. 31, 2025

(54) SYSTEM FOR NONDESTRUCTIVE MEASUREMENT OF A SAMPLE

(71) Applicant: Samsung Electronics Co., Ltd., Suwon-si (KR)

(72) Inventors: Joo Youn KANG, Suwon-si (KR); Eun Joo LEE, Suwon-si (KR); Jae Yoon KO, Suwon-si (KR); Eun Jeong PARK, Suwon-si (KR); Min Su JO, Suwon-si (KR); Kwang Soo KIM, Suwon-si (KR); Wook Rae KIM, Suwon-si (KR)

(21) Appl. No.: 18/918,838

(22) Filed: Oct. 17, 2024

(30) Foreign Application Priority Data
Jan. 31, 2024 (KR) 10-2024-0014635

(51) Int. Cl. G01N 21/55; G01N 21/25; G01N 21/31; G01N 21/88

(52) U.S. Cl. CPC G01N 21/55; G01N 21/255; G01N 21/3151; G01N 21/8806; G01N 21/8851; G01N 2021/8845; G01N 2021/8874

(57) ABSTRACT

A system for nondestructive measurement of a sample, the system includes a stage configured to support the sample thereon; a light source unit configured to output a pump beam having a first inspection wavelength and a probe beam having a second inspection wavelength; a beam delayer configured to delay a path of one of the pump beam and the probe beam; an optical system configured to provide the pump beam and the probe beam to the sample; a detector configured to detect the probe beam reflected from the sample; and a processor configured to: determine at least one of the first inspection wavelength and the second inspection wavelength so that a change in a reflectance at which the probe beam is reflected from the sample is maximized; and determine characteristics of the sample based on the probe beam reflected from the sample.

### CROSS-REFERENCE TO RELATED APPLICATION

This application claims priority under 35 U.S.C. § 119 from Korean Patent Application No. 10-2024-0014635, filed on Jan. 31, 2024, in the Korean Intellectual Property Office, and all the benefits accruing therefrom under 35 U.S.C. § 119, the contents of which in its entirety are herein incorporated by reference.

### BACKGROUND

### Field

The present disclosure relates to a system for nondestructive measurement of a sample. More specifically, the present disclosure relates to a system that measures characteristics of a sample based on a measurement of a photoacoustic effect using an ultrashort laser pump-probe pulse.

### Description of Related Art

Picosecond ultrasonic wave measurement is a type of a non-destructive measurement method. In this method, an ultrasonic wave is generated within a thin film disposed on a substrate using a laser pulse, and the ultrasonic wave changes optical properties of the thin film, such as reflectance. It is known that a thickness of the thin film may be measured based on change in the optical properties of the thin film.

### SUMMARY

A technical purpose that the present disclosure seeks to achieve is to provide a system that may measure characteristics of a sample more quickly and sensitively using a pump beam and a probe beam optimized based on the sample.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

According to an aspect of the present disclosure, a system for nondestructive measurement of a sample, the system includes a stage configured to support the sample thereon; a light source unit configured to output a pump beam having a first inspection wavelength and a probe beam having a second inspection wavelength; a beam delayer configured to delay a path of one of the pump beam and the probe beam; an optical system configured to provide the pump beam and the probe beam to the sample; a detector configured to detect the probe beam reflected from the sample; and a processor configured to: determine at least one of the first inspection wavelength and the second inspection wavelength so that a change in a reflectance at which the probe beam is reflected from the sample is maximized; and determine characteristics of the sample based on the probe beam reflected from the sample.

According to another aspect of the present disclosure, a system for nondestructive measurement of a sample, the system includes a stage; a light source configured to emit a broadband laser beam; a beam splitter configured to split the broadband laser beam into a first beam and a second beam; a first wavelength selector configured to output a pump beam having a first wavelength from the first beam; a second wavelength selector configured to output a probe beam having a second wavelength from the second beam; a beam delayer configured to delay a path of one of the pump beam and the probe beam; an optical system configured to provide the pump beam and the probe beam to the sample placed on the stage; a detector configured to detect the probe beam reflected from the sample; and a processor configured to: control the first wavelength selector and the second wavelength selector to change the first wavelength and the second wavelength, respectively; and store therein a change in a reflectance at which the probe beam is reflected from the sample for the first wavelength, and a change in a reflectance at which the probe beam is reflected from the sample for the second wavelength.

According to another aspect of the present disclosure, a system for nondestructive measurement of a sample, the system includes a stage configured to support the sample thereon; a light source unit configured to output a pump beam having a first wavelength and a probe beam having a second wavelength; a beam delayer configured to delay a path of one of the pump beam and the probe beam; an optical system configured to provide the pump beam and the probe beam to the sample; a detector configured to detect the probe beam reflected from the sample; and a processor configured to: control the light source unit to change the first wavelength and the second wavelength; and determine a first inspection wavelength and a second inspection wavelength, based on a change in a reflectance at which the probe beam is reflected from the sample for the first wavelength, and a change in a reflectance at which the probe beam is reflected from the sample for the second wavelength, wherein the light source unit is configured to output the pump beam having the first inspection wavelength and the probe beam having the second inspection wavelength, wherein the detector is configured to detect the probe beam having the second inspection wavelength reflected from the sample, wherein the processor is configured to determine characteristics of the sample, based on a change in a reflectance at which the probe beam having the second inspection wavelength is reflected from the sample.

### BRIEF DESCRIPTION OF DRAWINGS

The above and other aspects and features of the present disclosure will become more apparent by describing in detail illustrative embodiments thereof with reference to the attached drawings, in which:

FIG. 1 is a schematic diagram for illustrating a system for nondestructive measurement of a sample according to some example embodiments;

FIG. 2 and FIG. 3 are diagrams for illustrating an operation of a system for nondestructive measurement of a sample according to some example embodiments;

FIG. 4 is a flowchart for illustrating a method for optimizing a wavelength of a pump beam according to some example embodiments;

FIG. 5 is a diagram showing a spectrum of change in a reflectance of a probe beam based on a first wavelength of a pump beam according to a method according to some example embodiments;

FIG. 6 is a flowchart for illustrating a method for optimizing a wavelength of a probe beam according to some example embodiments;

FIG. 7 is a flowchart for illustrating a method for determining characteristics of a sample according to some example embodiments;

FIG. 8 is a flowchart for illustrating a method for determining characteristics of the sample according to some example embodiments.

FIG. 9 is a flowchart for illustrating a method for determining characteristics of the sample according to some example embodiments;

FIG. 10 is a schematic diagram for illustrating a system for nondestructive measurement of a sample according to some example embodiments; and

FIG. 11 is a flowchart for illustrating a semiconductor device manufacturing method using a measurement method according to some example embodiments.

### DETAILED DESCRIPTION

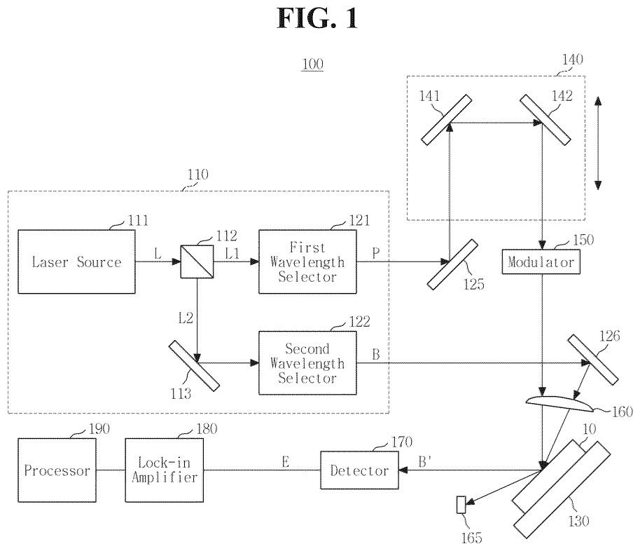

FIG. 1 is a schematic diagram for illustrating a system for nondestructive measurement of a sample according to some example embodiments. Like reference characters refer to like elements throughout.

Although the figures described herein may be referred to using language such as “one embodiment,” or “certain embodiments,” these figures, and their corresponding descriptions are not intended to be mutually exclusive from other figures or descriptions, unless the context so indicates. Therefore, certain aspects from certain figures may be the same as certain features in other figures, and/or certain figures may be different representations or different portions of a particular exemplary embodiment.

Referring to FIG. 1, a system 100 for nondestructive measurement of a sample according to some embodiments includes a light source unit 110, a stage 130, a beam delaying means 140, an optical means 160, a detector 170, and a processor 190.

The light source unit 110 may include a light source 111, a beam splitter 112, a first wavelength selector 121, and a second wavelength selector 122.

The light source 111 may emit a broadband laser beam L. The laser beam L may have any repetition rate, any pulse duration, and any wavelength. The light source 111 may generate a femtosecond pulse laser. The laser beam L may be a laser with a pulse width of about 10 to 15 seconds. The light source 111 may generate a pulse laser with a pulse width of several picoseconds or smaller. The laser beam L may be a laser with a pulse width of 10 to 12 seconds or smaller. The light source 111 may include, for example, a supercontinuum laser.

The beam splitter 112 may split the laser beam L into a first beam L1 and a second beam L2. The first wavelength selector 121 may select a wavelength of the first beam L1. The first wavelength selector 121 may select the wavelength of the first beam L1 under control of the processor 190. The first wavelength selector 121 may output a pump beam P with a specific wavelength from the first beam L1. The first wavelength selector 121 may change a center frequency and a bandwidth of the first beam L1. The first wavelength selector 121 may include, for example, a tunable bandpass filter.

The second beam L2 may be reflected from a mirror 113 so as to be incident on the second wavelength selector 122. The number and/or an arrangement of mirrors 113 may vary. The second wavelength selector 122 may select a wavelength of the second beam L2. The second wavelength selector 122 may select the wavelength of the second beam L2 under the control of the processor 190. The second wavelength selector 122 may output a probe beam B with a specific wavelength from the second beam L2. The second wavelength selector 122 may change a center frequency and a bandwidth of the second beam L2. The second wavelength selector 122 may include, for example, a variable bandpass filter.

The sample 10 may be placed on the stage 130. The stage 130 may support the sample 10 thereon. The stage 130 may be movable in a direction parallel to an upper surface of the sample 10 and in a direction perpendicular to the upper surface of the sample 10 under the control of the processor 190, for example. The stage 130 may be controlled by a motor, etc., which may cause the stage 130 to move in the direction parallel to the upper surface of the sample 10.

The beam delaying means 140 may delay a path of either the pump beam P or the probe beam B.

In some embodiments, the beam delaying means 140 may delay the path of the pump beam P.

The beam delaying means 140 may be disposed between the first wavelength selector 121 and the sample 10. The pump beam P may be reflected from the mirror 125 so as to be incident on the beam delaying means 140. The beam delaying means 140 may be movable so as to be closer to or away from the mirror 125 under the control of the processor 190, for example. The path of the pump beam P may be adjusted according to the movement of the beam delaying means 140. As the beam delaying means 140 approaches the mirror 125, the path of the pump beam P may become shorter, and a delay between the pump beam P and the probe beam B may be shortened.

For example, the beam delaying means 140 may be disposed on a stage controlled by a motor, etc. A distance between the beam delaying means 140 and the mirror 125 may be adjusted according to movement of the stage. For example, the stage may be controlled by a motor, which may cause to stage to move closer to or farther from the mirror 125.

The beam delaying means 140 may include a plurality of mirrors 141 and 142. The pump beam P may be reflected from the mirror 141 and a mirror 142 in this order and then may pass through the optical means 160, and be incident on the sample 10. The number and/or an arrangement of the plurality of mirrors 141 and 142 included in the beam delaying means 140 may vary.

The probe beam B may be reflected from the mirror 126, pass through the optical means 160, and be incident on the sample 10. The number and/or an arrangement of mirrors 126 may vary.

The optical means 160 may irradiate the pump beam P and the probe beam B to the sample 10. The optical means 160 may include, for example, a lens.

The modulator 150 may be disposed between the first wavelength selector 121 and the optical means 160. For example, the modulator 150 may be disposed between the beam delaying means 140 and the optical means 160.

The pump beam P may be reflected from the mirror 142 and may be incident on the modulator 150. The modulator 150 may modulate an intensity of the pump beam P to a specific frequency. The modulator 150 may include a chopper, an electro-optic modulator (EOM), etc.

The probe beam B may be reflected from the sample 10 as a probe beam B′. The detector 170 may detect the probe beam B′ reflected from the sample 10. The detector 170 may measure an intensity of the reflected probe beam B′. The detector 170 may convert the reflected probe beam B′ into an echo signal E as an electrical signal in an analog or digital form. The detector 170 may include, for example, a photoreceiver, a photodetector, a balanced photodetector, etc.

The lock-in amplifier 180 may be connected to the detector 170. The lock-in amplifier 180 may selectively output only a component of the echo signal E having the same frequency as the specific frequency to which the modulator 150 has modulated the pump beam P. The lock-in amplifier 180 may amplify only the component of the echo signal E having the same frequency as the specific frequency without a noise component having a different frequency from the specific frequency.

A beam dump 165 may collect the pump beam P reflected from the sample 10.

The processor 190 may control overall operations of the system 100 for nondestructive measurement of the sample.

The processor 190 may determine at least one of a first inspection wavelength of the pump beam P and a second inspection wavelength of the probe beam B so that the intensity of the probe beam B′ reflected from the sample 10 is maximized. The processor 190 may determine at least one of the first inspection wavelength and the second inspection wavelength from a database including an intensity of the probe beam B′ reflected from the sample 10 based on the wavelength of the pump beam P and an intensity of the probe beam B′ reflected from the sample 10 based on the wavelength of the probe beam B′.

The first wavelength selector 121 and the second wavelength selector 122 may respectively output a pump beam P having the first inspection wavelength and a probe beam B having the second inspection wavelength under the control of the processor 190. The processor 190 may measure the characteristics of the sample 10 using the pump beam P having the first inspection wavelength and the probe beam B having the second inspection wavelength. The processor 190 may measure the characteristics of the sample 10 based on the intensity of the probe beam B′ reflected from the sample 10.

For example, the processor 190 may be embodied as a processor such as a central processing unit (CPU), a graphics processing unit (GPU), a microprocessor, an application specific integrated circuit (ASIC), or a field programmable gate array (FPGA) or may be embodied as a general PC (personal computer) including one or more of the aforementioned processors.

The processor 190 may be equipped with a memory to store therein various data necessary for the operation of the system 100 for nondestructive measurement of the sample. Various databases may be stored in the memory. The memory may include, for example, random access memory (RAM), dynamic RAM (DRAM), NAND flash memory, read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium) where data and/or instructions can be stored.

The processor 190 may allow the pump beam P having the first inspection wavelength and the probe beam B having the second inspection wavelength to be irradiated to the sample 10, and may measure the characteristics of the sample 10 based on the probe beam B′ reflected from the sample 10. The characteristics may include a thickness of the sample 10, a material of the sample 10, whether there is a void in the sample 10, a location of the void in the sample 10, etc.

The processor 190 may receive the echo signal E output from the lock-in amplifier 180. The processor 190 may measure the characteristics of the sample 10 based on the echo signal E.

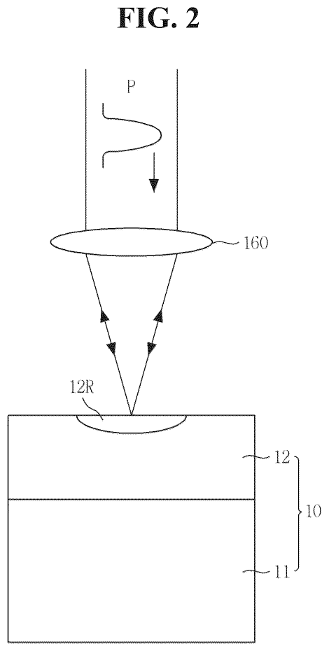

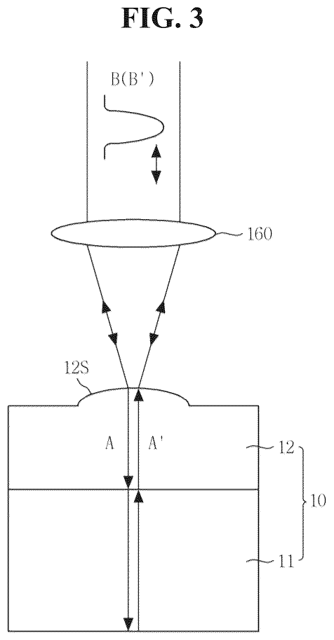

FIG. 2 and FIG. 3 are diagrams for illustrating an operation of a measurement system according to some example embodiments.

Referring to FIG. 1 and FIG. 2, an example in which the sample 10 includes a plurality of films is described.

The sample 10 may include a lower film 11 and an upper film 12. Hereinafter, an example in which an ultrasonic wave acoustic wave is generated in the upper film 12 is described. The upper film 12 may include metal, for example.

The pump beam P may be irradiated to the upper film 12 through the optical means 160. Electrons in a surface of the upper film 12 may absorb energy of photons of the pump beam P and may be excited to a higher energy level, and then be diffused to transfer energy to a lattice of the upper film 12. As a result, local thermal expansion may be induced in an area 12R of the upper film 12, and the ultrasonic wave (e.g., ultrasonic wave A in FIG. 3) may be generated in a direction perpendicular to the upper surface of the upper film 12 due to thermal stress.

Referring to FIG. 1 and FIG. 3, the ultrasonic wave A may travel in a direction perpendicular to the upper surface of the upper film 12. A portion of the ultrasonic wave A may be reflected from an interface between the upper film 12 and the lower film 11 toward the upper surface of the upper film 12. Furthermore, a portion of the ultrasonic wave A may be reflected from a lower surface of the lower film 11 toward the upper surface of the upper film 12.

The probe beam B may be irradiated to the upper film 12 through the optical means 160. The moment a reflected ultrasonic wave A′ reaches a surface 12S of the upper film 12, a strain of the surface 12S of the upper film 12 changes, such that a reflectance at which the probe beam B′is reflected from the upper film 12 may change. The reflectance of the probe beam B′ may be measured based on the change in the intensity of the probe beam B′. In other words, the pump beam P may generate the strain in the upper film 12 so that the ultrasonic wave is generated in the sample 10. The strain may be measured using the probe beam B.

The measurement system according to some embodiments may determine the characteristics of the sample 10 using the pump beam P optimized for the strain generation of the sample 10 and the probe beam B optimized for strain measurement. The measurement system according to some embodiments may generate the ultrasonic wave in the film using the pump beam P with a wavelength optimized for the film.

When generating the ultrasonic wave in the upper film 12 of the sample 10, the ultrasonic wave may be generated using the pump beam P optimized for generating the strain in the upper film 12. When the pump beam P in a wavelength range in which the beam is easily absorbed by the upper film 12 is radiated to the upper film 12, even a low-energy pump beam P may efficiently generate the ultrasonic wave A in the upper film 12. Furthermore, as the pump beam P having a higher rate at which the pump beam P is absorbed into the film is used, the ultrasonic wave A having the higher frequency may be generated. Therefore, as the pump beam P having a higher rate at which the pump beam P is absorbed into the film is used, the ultrasonic wave A having the shorter wavelength may be generated, such that a resolution may be improved. In other words, a thin film and a small defect may be observed at a high resolution. Furthermore, the characteristics of the sample 10 may be determined more efficiently using the probe beam B optimized for strain measurement.

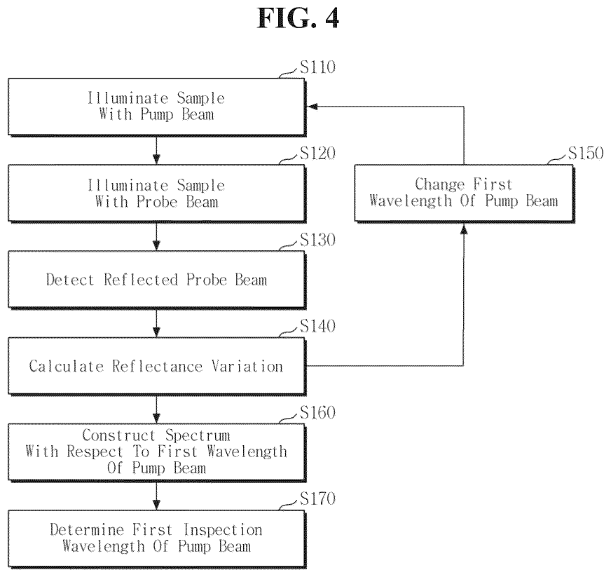

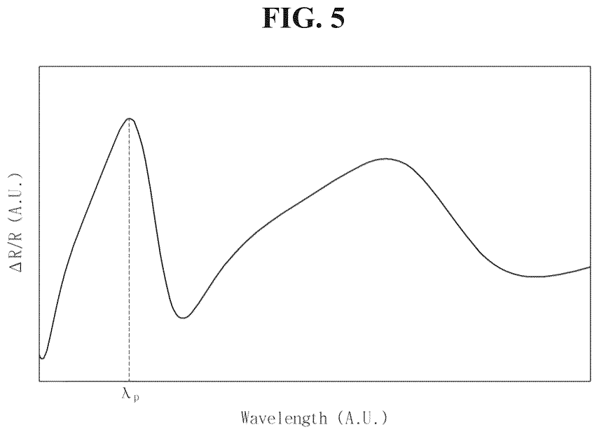

FIG. 4 is a flowchart for illustrating a method of optimizing a wavelength of the pump beam according to some example embodiments. FIG. 5 is a diagram showing a spectrum of a change in a reflectance of the probe beam based on a first wavelength of the pump beam according to a method according to some example embodiments.

Referring to FIG. 4, the pump beam is radiated to the sample in S110. The probe beam is irradiated to the sample in S120. The measurement system (e.g., detector 170) detects the probe beam reflected from the sample in S130. The measurement system (e.g., processor 190) calculates the change in the reflectance at which the probe beam is reflected from the sample in S140. The measurement system (e.g., first wavelength selector 121) changes the first wavelength of the pump beam in S150. After changing the first wavelength of the pump beam, the system irradiates the pump beam with the changed first wavelength to the sample in S110, irradiates the probe beam to the sample in S120, detects the probe beam reflected from the sample in S130, and calculates the change in the reflectance at which the probe beam is reflected from the sample in S140. The measurement system may repeat the steps S110 to S150 and may calculate the change in the reflectance at which the probe beam is reflected from the sample based on the varying first wavelength of the pump beam. For example, the processor 190 may calculate the change in the reflectance at which the probe beam is reflected from the sample based on the varying first wavelength of the pump beam. Step S120 may be performed after step S110 is performed. Alternative, after step S120 is performed, step S110 may be performed.

The measurement system generates a spectrum of the change in the reflectance of the probe beam based on the varying first wavelength of the pump beam in S160. Based on the spectrum of the change in the reflectance of the probe beam based on the varying first wavelength of the pump beam, the system determines the first inspection wavelength of the pump beam in S170.

For example, referring to FIGS. 1 to 4, the laser beam L output from the light source 111 may be split into the first and second beams L1 and L2 by the beam splitter 112. The pump beam P having the first wavelength selected from the first beam L1 by the first wavelength selector 121 may be output. The probe beam B having the second wavelength selected from the second beam L2 by the second wavelength selector 122 may be output.

The pump beam P may be irradiated to the sample 10 in S110. The pump beam P may be irradiated to the sample 10 through the mirror 125, the beam delaying means 140, the modulator 150, and the optical means 160. The ultrasonic wave A may be generated in the sample 10 by the pump beam P.

The probe beam B may be irradiated to the sample 10 in S120. The probe beam B may be irradiated to the sample 10 through the mirror 126 and the optical means 160.

The detector 170 may detect the probe beam B′ reflected from the sample 10 in S130. The detector 170 may convert the reflected probe beam B′ into the echo signal E and provide the echo signal to the processor 190.

The processor 190 may calculate the change in the reflectance at which the probe beam B is reflected from the sample 10 based on the echo signal E in S140. For example, the processor 190 may calculate the change in the reflectance at which the probe beam B is reflected from the sample 10 based on the intensity of the echo signal E.

The first wavelength selector 121 may change the first wavelength of the pump beam P under the control of the processor 190 in S150. The measurement system may repeat steps S110 to S150. Then, the processor 190 may calculate the change in the reflectance at which the probe beam B is reflected from the sample 10 based on the varying first wavelength of the pump beam P in S140. The processor 190 may generate a spectrum of the change in the reflectance at which the probe beam B is reflected from the sample 10 based on the varying first wavelength of the pump beam P in S160.

The processor 190 may determine the first inspection wavelength λP of the pump beam P based on the spectrum generated in step S160 in S170. For example, referring to FIG. 1 and FIG. 5, the processor 190 may determine a wavelength of the pump beam P at which the change in the reflectance at which the probe beam B is reflected from the sample 10 is the largest, as the first inspection wavelength λP.

The processor 190 may store therein the spectrum of the change in the reflectance at which the probe beam B is reflected from the sample 10 based on the varying first wavelength of the pump beam P generated in step S160.

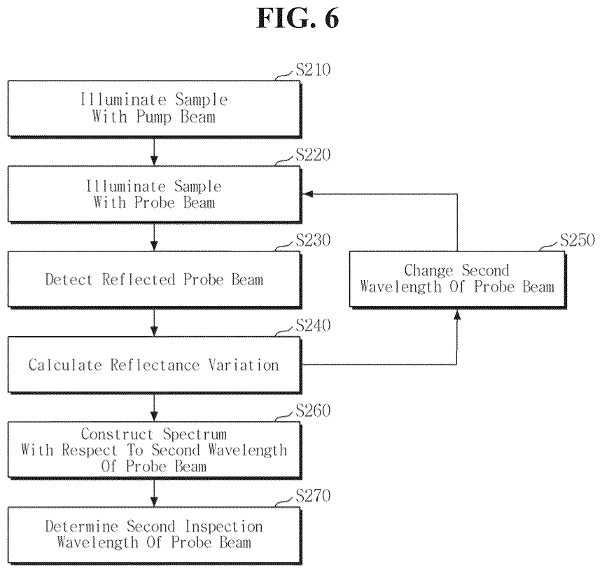

FIG. 6 is a flowchart for illustrating a method for optimizing a wavelength of the probe beam according to some example embodiments.

Referring to FIG. 6, the pump beam is radiated to the sample in S210. The measurement system irradiates the probe beam B to the sample in S220. The measurement system detects the probe beam reflected from the sample in S230. The measurement system calculates the change in the reflectance at which the probe beam is reflected from the sample in S240. The measurement system changes the second wavelength of the probe beam in S250. After changing the second wavelength of the probe beam, the system irradiates the probe beam with the changed second wavelength to the sample in S220, detects the probe beam reflected from the sample in S230, and calculates the change in the reflectance at which the probe beam is reflected from the sample in S240. The measurement system may repeat steps S220 to S250, and may calculate the change in the reflectance at which the probe beam is reflected from the sample based on second wavelength of the probe beam. Step S220 may be performed after step S210 is performed. Alternatively, after step S220 is performed, step S210 may be performed.

The measurement system generates a spectrum of the change in the reflectance of the probe beam based on the varying second wavelength of the probe beam in S260. Based on the spectrum of the change in the reflectance of the probe beam based on the varying second wavelength of the probe beam, the system determines the second inspection wavelength of the probe beam in S270.

For example, referring to FIG. 1 and FIG. 6, the pump beam P may be irradiated to the sample 10 in S210. The pump beam P may be irradiated to the sample 10 through the mirror 125, the beam delaying means 140, the modulator 150, and the optical means 160. The ultrasonic wave A may be generated in the sample 10 by the pump beam P.

The probe beam B may be irradiated to the sample 10 in S220. The probe beam B may be irradiated to the sample 10 through the mirror 126 and the optical means 160.

The detector 170 may detect the probe beam B′ reflected from the sample 10 in S230. The detector 170 may convert the reflected probe beam B′ into the echo signal E and provide the echo signal to the processor 190.

The processor 190 may calculate the change in the reflectance at which the probe beam B is reflected from the sample 10 based on the echo signal E in S240. For example, the processor 190 may calculate the change in the reflectance at which the probe beam B is reflected from the sample 10 based on the intensity of the echo signal E.

The second wavelength selector 122 may change the second wavelength of the probe beam B under the control of the processor 190 in S250. The measurement system may repeat steps S220 to S250. Thus, the processor 190 may calculate the change in the reflectance at which the probe beam B is reflected from the sample 10 based on second wavelength of the probe beam B in S240. The processor 190 may generate the spectrum of the change in the reflectance at which the probe beam B is reflected from the sample 10 based on the varying second wavelength of the probe beam B in S260.

The processor 190 may determine the second inspection wavelength of the probe beam B based on the spectrum generated in step S260 in S270. For example, the processor 190 may determine a wavelength of the probe beam B at which the change in the reflectance at which the probe beam B is reflected from the sample 10 is the greatest, as the second inspection wavelength.

The processor 190 may store therein the spectrum of the change in the reflectance at which the probe beam B is reflected from the sample 10 based on the varying second wavelength of the probe beam B generated in step S260.

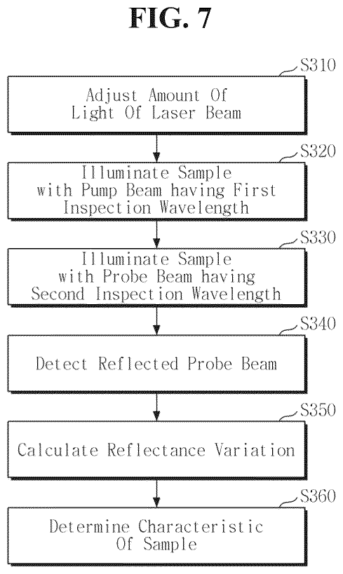

FIG. 7 is a flowchart for illustrating a method for determining characteristics of the sample according to some example embodiments.

Referring to FIG. 7, an amount of light of the laser beam is adjusted in S310. The pump beam with the first inspection wavelength is irradiated to the sample in S320. The first inspection wavelength is the wavelength determined in step S170 in FIG. 4. The probe beam with the second inspection wavelength is irradiated to the sample in S330. The second inspection wavelength is the wavelength determined in step S270 in FIG. 6.

The measurement system detects the probe beam reflected from the sample in S340. The measurement system calculates the change in the reflectance at which the probe beam is reflected from the sample in S350. Based on the change in the reflectance at which the probe beam is reflected from the sample, the characteristics of the sample are determined by the measurement system in S360.

Referring to FIG. 1 and FIG. 7, the light source 111 may adjust the amount of light of the laser beam L under the control of the processor 190 in S310. Accordingly, the light source 111 may output the laser beam L with sufficient energy to generate the ultrasonic wave in the sample 10. Furthermore, the performance of the first and second wavelength selectors 121 and 122 may vary depending on a wavelength band. The amount of light of the laser beam L may be adjusted such that the performance of the first and second wavelength selectors 121 and 122, which varies depending on the wavelength band may be corrected. In other words, the light amount of the laser beam L may be adjusted so that the light amount of each of the pump beam P and the probe beam B is constant in all wavelength bands.

The first wavelength selector 121 may output the pump beam P having the first inspection wavelength determined in step S170 of FIG. 4 under the control of the processor 190. The pump beam P having the first inspection wavelength may be irradiated to the sample 10 in S320. The second wavelength selector 122 may output the probe beam B having the second inspection wavelength determined in step S270 of FIG. 6 under the control of the processor 190. The probe beam B having the second inspection wavelength may be irradiated to the sample 10 in S330. The detector 170 may detect the probe beam B′ reflected from the sample 10 in S340. The detector 170 may convert the reflected probe beam B′ into the echo signal E. The processor 190 may calculate the change in the reflectance at which the probe beam B is reflected from the sample 10 based on the echo signal E in S350. The processor 190 may determine the characteristics of the sample 10 based on the change in the reflectance at which the probe beam B is reflected from the sample 10 in S360.

In some embodiments, the characteristics of the sample 10 may include the thickness of the sample 10.

The processor 190 may measure a time for which the ultrasonic wave A travels in a vertical direction (for example, a direction perpendicular to the upper surface of the sample 10) and is reflected back from the interface between the upper film 12 and the lower film 11 and returns to the system, based on the change in the reflectance at which the probe beam B is reflected from the sample 10. The processor 190 may calculate the thickness of the upper film 12 by multiplying the measured time by the speed of sound and 0.5. For example, the processor 190 may calculate the thickness of the upper film 12 by multiplying the measured time by 343 meters/second and 0.5 (e.g., multiplying the measured time by 171.5 meters/second). Furthermore, the processor may measure a time for which the ultrasonic wave A travels in the vertical direction and is reflected from the lower surface of the lower film 11, and returns to the system, based on the change in the reflectance of the probe beam B. The processor 190 may calculate the thickness of the sample 10 by multiplying the measured time by the speed of sound and 0.5. For example, the processor 190 may calculate the thickness of the sample 10 by multiplying the measured time by 343 meters/second and 0.5 (e.g., multiplying the measured time by 171.5 meters/second).

The processor 190 may store in memory the spectrum of the change in the reflectance of the probe beam B based on the varying first wavelength of the pump beam P, based on a film material and/or a film thickness. Accordingly, the processor 190 may build a database including the spectrum of the change in the reflectance of the probe beam B based on the varying first wavelength of the pump beam P, based on the film material and/or the film thickness.

Furthermore, the processor 190 may store in memory the spectrum of the change in the reflectance of the probe beam B based on the varying second wavelength of the probe beam B, based on the film material and/or the film thickness. Accordingly, the processor 190 may build a database including the spectrum of the change in the reflectance of the probe beam B based on the varying second wavelength of the probe beam B, based on the film material and/or the film thickness.

In some embodiments, the system 100 for nondestructive measurement of the sample may measure the characteristics of the sample 10 more quickly and at a higher sensitivity using the database stored in the processor 190.

Alternatively, the database containing the spectrum of the change in the reflectance of the probe beam B based on the varying first wavelength of the pump beam P, based on the material of the film and/or thickness of the film and/or the database containing the spectrum of the change in the reflectance of the probe beam B based on the varying second wavelength of the probe beam B, based on the material of the film and/or thickness of the film may be pre-stored in the processor 190. Alternatively, the processor 190 may receive the database from an external source and measure the characteristics of the sample 10 based on the database.

In some embodiments, the characteristics of the sample10 may include whether there is a void in the sample 10.

The processor 190 may generate a graph of the echo signal E based on a time domain. The processor 190 may include a database containing the echo signal E based on the time domain when the void does not exist in the film, based on the film thickness and/or the film material. The processor 190 may compare the database with the echo signal E based on the time domain generated through step S350 and may determine whether the void is present in the sample 10 based on the comparing result. Alternatively, the processor 190 may receive the database from an external source.

For example, the processor 190 may determine that the void is present in the sample 10 upon determination that a difference between an echo signal E1 and an echo signal E2 is greater than or equal to a specific value. When the difference is smaller than the specific value, it may be determined that the void is absent in the sample 10.

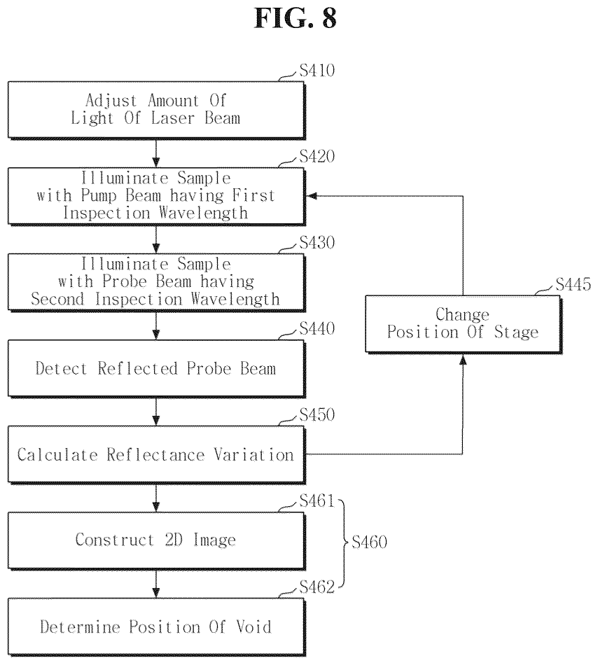

FIG. 8 is a flowchart for illustrating a method for determining characteristics of the sample according to some example embodiments. For convenience of description, the following description focuses on differences thereof from the description set forth above with reference to FIG. 1 to FIG. 7.

Steps S410 to S460 in FIG. 8 may respectively correspond to steps S310 to S360 in FIG. 7.

Referring to FIG. 8, step S455 of changing a position of the stage may be further included in the method. The measurement system calculates the change in the reflectance at which the probe beam is reflected from the sample in S450 and changes the position of the stage in S455, and then irradiates the probe beam to the sample in S420. The measurement system detects the probe beam reflected from the sample in S430, and calculates the change in the reflectance at which the probe beam is reflected from the sample in S440. The measurement system may repeat steps S420 to S455, and may calculate the change in the reflectance at which the probe beam is reflected from the sample, based on the position of the stage.

In some embodiments, the characteristics of the sample may include a location of the void within the sample. The step of determining the characteristics of the sample based on the change in the reflectance at which the probe beam is reflected from the sample in S460 includes a step of generating a two-dimensional image in S461 and determining the position of the void based on the two-dimensional image in S462. For example, the processor 190 may generate a two-dimensional image and determine the position of the void based on the two-dimensional image.

Referring to FIG. 1 and FIG. 8, the position of the stage 130 may be changed under the control of the processor 190. The stage 130 may be movable in a direction parallel to the upper surface of the sample 10 (for example, the X direction and the Y direction). The processor 190 may calculate the change in the reflectance at which the probe beam B is reflected from the sample 10, based on the varying position (for example, a X-direction coordinate and a Y-direction coordinate) of the stage 130 in S450.

The processor 190 may generate a two-dimensional image based on the change in the reflectance of the probe beam B based on the varying position of the stage 130 in S461. The processor 190 may generate the two-dimensional image from the change in the reflectance of the probe beam B based on the varying position of the stage 130 using Fourier Transform or the like. The two-dimensional image may represent the change in the reflectance of the probe beam B depending on the varying position of the stage 130.

The processor 190 may store therein the two-dimensional image generated in step S461.

When the void is present in the sample 10, a material changes in the void, such that change in the reflectance of the probe beam B may appear discontinuously. When the void is present in the sample 10, change in a wavefront in the two-dimensional image may occur. The processor 190 may determine whether the void is present and the location of the void in the sample 10 based on the two-dimensional image. Furthermore, the processor 190 may determine a size of the void in the sample 10 based on the two-dimensional image.

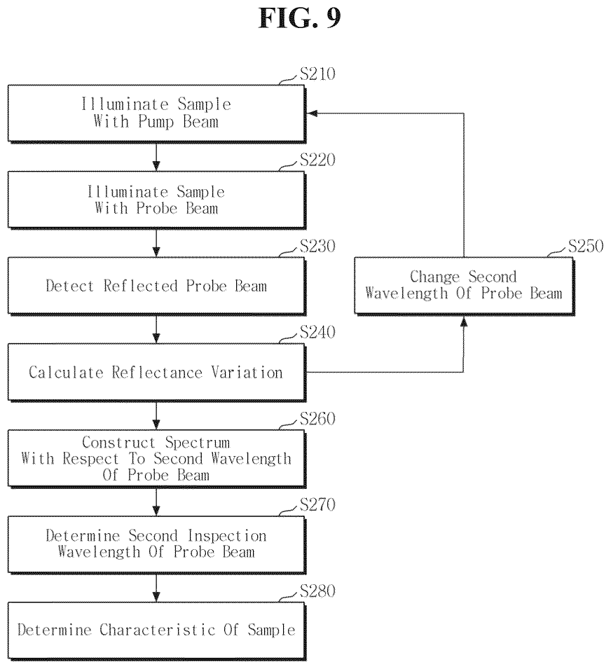

FIG. 9 is a flowchart for illustrating a method for determining characteristics of the sample according to some example embodiments. Differences thereof from what has been described above with reference to FIG. 1 to FIG. 6 will be described.

Referring to FIG. 9, the measurement system may generate a spectrum of the change in the reflectance of the probe beam at the varying second wavelength of the probe beam in S260, and determines the characteristics of the sample in S280.

Referring to FIG. 1 and FIG. 9, in some embodiments, the characteristics of the sample 10 may include a material of the sample 10.

The processor 190 may include a database containing the spectrum of the change in the reflectance of the probe beam at the varying second wavelength of the probe beam B, based on the film material and/or the film thickness. The processor 190 may determine the material of the sample 10 based on a comparing result between the database and the spectrum generated in step S260. Alternatively, the processor 190 may receive the database from an external source.

In some embodiments, when the position of the void in the sample 10 is determined in step S462 of FIG. 8, the material of the void may be determined by performing the steps S210 to S270 of FIG. 9 based on the determined location of the void.

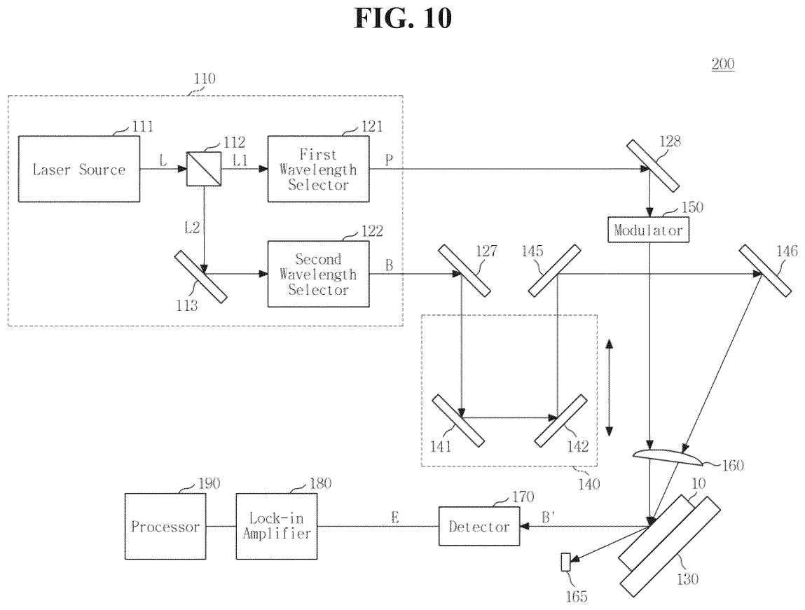

FIG. 10 is a schematic diagram for illustrating a measurement system according to some example embodiments. For convenience of description, the following description focuses on differences thereof from the description as set forth above with reference to FIGS. 1 to 9.

Referring to FIG. 10, in a system 200 for nondestructive measurement of a sample according to some embodiments, the beam delaying means 140 may delay the path of the probe beam B.

The beam delaying means 140 may be disposed between the second wavelength selector 122 and the sample 10. The probe beam B may be reflected from the mirror 127 and incident on the beam delaying means 140. The beam delaying means 140 may be movable so as to be closer to or away from the mirror 127 under the control of the processor 190, for example. The path of the probe beam B may be adjusted according to the movement of the beam delaying means 140. As the beam delaying means 140 approaches the mirror 127, the path of the probe beam B may become shorter, and the delay between the pump beam P and probe beam B may be shortened.

For example, the beam delaying means 140 may be disposed on a stage controlled by a motor, etc. A distance between the beam delaying means 140 and the mirror 127 may be adjusted according to the movement of the stage.

The probe beam B may be sequentially reflected from the mirror 127, the mirror 145, and the mirror 146 in this order, and pass through the optical means 160, and be incident on the sample 10. The number and/or an arrangement of the mirrors 127, 145, and 146 may vary.

The pump beam P may be reflected from the mirror 128, pass through the optical means 160, and be incident on the sample 10. The pump beam P may be reflected from the mirror 128 and be incident on the modulator 150.

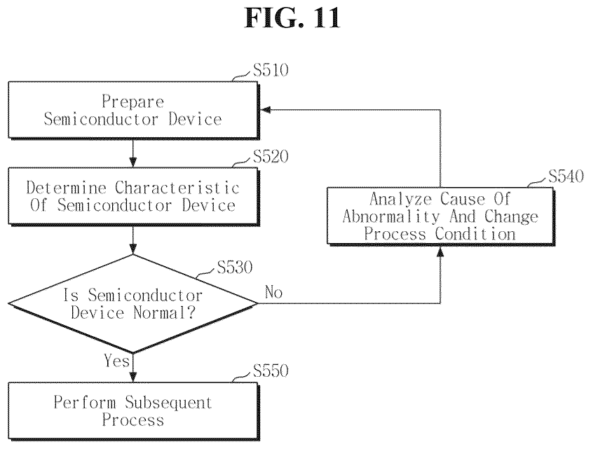

FIG. 11 is a flowchart for illustrating a semiconductor device manufacturing method using the measurement method according to some example embodiments. Following description focuses on differences thereof from what has been described above with reference to FIG. 1 to FIG. 10.

Referring to FIG. 11, the method prepares a semiconductor device as a measurement target in S510. The semiconductor device may be, for example, a mask, a wafer, or a portion corresponding to a shot or a chip within the wafer. In one example, the preparation of the semiconductor device may include a process of manufacturing the semiconductor device.

The method determines the characteristics of the semiconductor device in S520.

The step of determining the characteristics of the semiconductor device in S520 may be similar to the determining of the characteristics of the sample as described above with reference to FIG. 7. The step of determining the characteristics of the semiconductor device in S520 may include adjusting the amount of light of the laser beam, irradiating the pump beam with the first inspection wavelength to the semiconductor device, irradiating the probe beam with the second inspection wavelength to the semiconductor device, calculating the change in the reflectance at which the probe beam is reflected from the semiconductor device, and determining the characteristics of the semiconductor device, based on the reflectance at which the probe beam is reflected from the semiconductor device. The characteristics of the semiconductor device may include a thickness of a specific film within the semiconductor device, and whether there is a void within the semiconductor device.

The step of determining the characteristics of the semiconductor device in S520 may be similar to the determining of the characteristics of the sample as described above with reference to FIG. 9. The step of determining the characteristics of the semiconductor device in S520 may include adjusting the amount of light of the laser beam, irradiating the pump beam with the first inspection wavelength to the semiconductor device, irradiating the probe beam with the second inspection wavelength to the semiconductor device, changing the position of the stage, calculating the change in the reflectance at which the probe beam is reflected from the semiconductor device, based on the varying position of the stage, and determining the characteristics of the semiconductor device, based on the change in the reflectance at which the probe beam is reflected from the semiconductor device based on the varying position of the stage. The characteristics of the semiconductor device may include a location of the void within the semiconductor device.

The step of determining the characteristics of the semiconductor device in S520 may be similar to the determining of the characteristics of the sample as described above with reference to FIG. 9. The step of determining the characteristics of the semiconductor device in S520 may include irradiating the pump beam to the semiconductor device, irradiating the probe beam to the semiconductor device, changing the second wavelength of the probe beam, calculating the change in the reflectance at which the probe beam is reflected from the semiconductor device, based on the varying second wavelength of the probe beam, generating the spectrum of the reflectance at which the probe beam is reflected from the semiconductor device based on the varying second wavelength of the probe beam, and determining the characteristics of the semiconductor device, based on the generated spectrum. The characteristics of the semiconductor device may include the thickness of the specific film within the semiconductor device and a material of the specific film within the semiconductor device.

Based on the determined characteristics of the semiconductor device, the system determines whether the semiconductor device is normal in S530. When the semiconductor device is normal (Yes), a subsequent process on the semiconductor device is performed in S350. The subsequent process may be a plurality of subsequent processes. For example, the subsequent process on the semiconductor device may include a deposition process, an etching process, an ion process, a cleaning process, etc. Moreover, the subsequent process on the semiconductor devices may include a testing process on the semiconductor device at a wafer level. Furthermore, the subsequent process on the semiconductor device may include individualizing the wafer into semiconductor chips and packaging the semiconductor chips.

When the semiconductor device is abnormal (No), the method analyzes a cause of the abnormality and changes a process condition in S540. In this regard, the process condition may mean, for example, a process condition in a semiconductor process for manufacturing the semiconductor device. By way of example, in a lithography process, when the cause of the abnormality is related to a focus, the method may change a focus position. The method may change a dose amount when the cause thereof is related to a dose. Then, the method may proceed to a step of preparing the semiconductor device in S510. The semiconductor device in the step of preparing the semiconductor device in S510 may be a semiconductor device to which the changed process condition has been applied.

Although embodiments of the present disclosure have been described with reference to the accompanying drawings, embodiments of the present disclosure are not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

What is claimed is:

1. A system for nondestructive measurement of a sample, the system comprising:
a stage configured to support the sample thereon;
a light source unit configured to output a pump beam having a first inspection wavelength and a probe beam having a second inspection wavelength;
a beam delayer configured to delay a path of one of the pump beam and the probe beam;
an optical system configured to provide the pump beam and the probe beam to the sample;
a detector configured to detect the probe beam reflected from the sample; and
a processor configured to:
determine at least one of the first inspection wavelength and the second inspection wavelength so that a change in a reflectance at which the probe beam is reflected from the sample is maximized; and
determine characteristics of the sample based on the probe beam reflected from the sample.

2. The system for the nondestructive measurement of the sample of claim 1, wherein the light source unit includes:
a light source configured to emit a broadband laser beam;
a beam splitter configured to split the broadband laser beam into a first beam and a second beam;
a first wavelength selector configured to output the pump beam having the first inspection wavelength from the first beam; and
a second wavelength selector configured to output the probe beam having the second inspection wavelength from the second beam.

3. The system for the nondestructive measurement of the sample of claim 2, wherein the processor is configured to control an amount of light of the broadband laser beam.

4. The system for the nondestructive measurement of the sample of claim 3, wherein the processor is configured to determine the at least one of the first inspection wavelength and the second inspection wavelength and then control the amount of the light of the broadband laser beam.

5. The system for the nondestructive measurement of the sample of claim 2, wherein the beam delayer is disposed between the first wavelength selector and the sample.

6. The system for the nondestructive measurement of the sample of claim 2, wherein the beam delayer is disposed between the second wavelength selector and the sample.

7. The system for the nondestructive measurement of the sample of claim 1, wherein the characteristics of the sample include a thickness of the sample.

8. The system for the nondestructive measurement of the sample of claim 1, wherein the characteristics of the sample include whether a void is present in the sample.

9. The system for the nondestructive measurement of the sample of claim 1, wherein the characteristics of the sample include a material of the sample.

10. The system for the nondestructive measurement of the sample of claim 1,
wherein the processor is configured to control the stage to change a position of the stage, and
wherein the detector is configured to detect the probe beam reflected from the sample for each position of the stage.

11. The system for the nondestructive measurement of the sample of claim 10,
wherein the characteristics of the sample include a position of a void in the sample, and
wherein the processor is configured to determine the position of the void, based on the probe beam reflected from the sample for the each position of the stage.

12. A system for nondestructive measurement of a sample, the system comprising:
a stage;
a light source configured to emit a broadband laser beam;
a beam splitter configured to split the broadband laser beam into a first beam and a second beam;
a first wavelength selector configured to output a pump beam having a first wavelength from the first beam;
a second wavelength selector configured to output a probe beam having a second wavelength from the second beam;
a beam delayer configured to delay a path of one of the pump beam and the probe beam;
an optical system configured to provide the pump beam and the probe beam to the sample placed on the stage;
a detector configured to detect the probe beam reflected from the sample; and
a processor configured to:
control the first wavelength selector and the second wavelength selector to change the first wavelength and the second wavelength, respectively; and
store therein a change in a reflectance at which the probe beam is reflected from the sample for the first wavelength, and a change in a reflectance at which the probe beam is reflected from the sample for the second wavelength.

13. The system for the nondestructive measurement of the sample of claim 12, wherein the processor is configured to store therein the change in the reflectance at which the probe beam is reflected from the sample for the second wavelength for each material of the sample placed on the stage.

14. The system for the nondestructive measurement of the sample of claim 12, wherein the processor is configured to store therein the change in the reflectance at which the probe beam is reflected from the sample for the second wavelength for each thickness of the sample placed on the stage.

15. The system for the nondestructive measurement of the sample of claim 12, wherein the beam delayer is disposed between the second wavelength selector and the sample.

16. The system for the nondestructive measurement of the sample of claim 12, wherein the beam delayer is disposed between the first wavelength selector and the sample.

17. A system for nondestructive measurement of a sample, the system comprising:
a stage configured to support the sample thereon;
a light source unit configured to output a pump beam having a first wavelength and a probe beam having a second wavelength;
a beam delayer configured to delay a path of one of the pump beam and the probe beam;
an optical system configured to provide the pump beam and the probe beam to the sample;
a detector configured to detect the probe beam reflected from the sample; and
a processor configured to:
control the light source unit to change the first wavelength and the second wavelength; and
determine a first inspection wavelength and a second inspection wavelength, based on a change in a reflectance at which the probe beam is reflected from the sample for the first wavelength, and a change in a reflectance at which the probe beam is reflected from the sample for the second wavelength,
wherein the light source unit is configured to output the pump beam having the first inspection wavelength and the probe beam having the second inspection wavelength,
wherein the detector is configured to detect the probe beam having the second inspection wavelength reflected from the sample,
wherein the processor is configured to determine characteristics of the sample, based on a change in a reflectance at which the probe beam having the second inspection wavelength is reflected from the sample.

18. The system for the nondestructive measurement of the sample of claim 17, wherein the characteristics of the sample include at least one of a thickness of the sample, whether a void is present in the sample, and a material of the sample.

19. The system for the nondestructive measurement of the sample of claim 17, wherein the characteristics of the sample include a position of a void in the sample,
wherein the processor is configured to control the stage to change a position of the stage,
wherein the detector is configured to detect the probe beam having the second inspection wavelength reflected from the sample for each position of the stage, and
wherein the processor is configured to:
generate a two-dimensional image of the probe beam having the second inspection wavelength reflected from the sample for the each position of the stage; and
determine the position of the void in the sample based on the two-dimensional image.

20. The system for the nondestructive measurement of the sample of claim 19,
wherein the characteristics of the sample include a size of the void, and
wherein the processor is further configured to determine the size of the void based on the two-dimensional image.
